(19) United States
(12) Patent Application Publication
(10) Pub. No.: US 2006/0233246 A1
(43) Pub. Date: Oct. 19, 2006

(54) Method and apparatus for encoding, transmitting, and decoding a video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,157

(22) Filed: Dec. 5, 2005

Related U.S. Application Data
(60) Provisional application No. 60/632,973, filed on Dec. 6, 2004.

(30) Foreign Application Priority Data
Jun. 10, 2005 (KR) 10-2005-0049897

(51) Int. Cl. H04B 1/66; H04N 7/12

(52) U.S. Cl. 375/240.12

(57) ABSTRACT

In one embodiment of a method of decoding a video signal, at least a portion of a picture in a first picture sequence layer is decoded based on a second picture sequence layer if an indicator in the video signal indicates inter-layer prediction coding.

### DOMESTIC PRIORITY INFORMATION

This application claims priority under 35 U.S.C. §119 on U.S. provisional application 60/632,973, filed Dec. 6, 2004; the entire contents of which are hereby incorporated by reference.

### FOREIGN PRIORITY INFORMATION

This application claims priority under 35 U.S.C. §119 on Korean Application No. 10-2005-0049897, filed Jun. 10, 2005; the entire contents of which are hereby incorporated by reference.

### BACKGROUND OF THE INVENTION

1. Field of the Invention

The present invention relates to a method and apparatus for encoding and transmitting a video signal according to a scalable scheme, a method and apparatus for decoding such an encoded data stream, and the encoded data stream.

2. Description of the Related Art

Scalable Video Codec (SVC) is a method which encodes video into a sequence of pictures with the highest image quality while ensuring that part of the encoded picture sequence (specifically, a partial sequence of frames intermittently selected from the total sequence of frames) can be decoded to represent the video with a lower image quality. Motion Compensated Temporal Filtering (MCTF) is an encoding scheme that has been suggested for use in the scalable video codec.

Although it is possible to represent low image-quality video by receiving and processing part of the sequence of pictures encoded in the scalable MCTF coding scheme as described above, there is still a problem in that the image quality is significantly reduced if the bitrate is lowered. One solution to this problem is to hierarchically and additionally provide an auxiliary picture sequence for low bitrates, for example, a sequence of pictures that have a small screen size and/or a low frame rate. One example is to encode and transmit 4CIF (Common Intermediate Format), CIF, and QCIF (Quarter CIF) picture sequences of a video signal to a decoding apparatus as shown in FIG. 1.

Such picture sequences have redundancy since the same video signal source is encoded into the sequences. To increase the coding efficiency of each sequence, one method entails inter-sequence prediction of video frames in a higher sequence from video frames in a lower sequence temporally coincident with the video frames in the higher sequence, so as to reduce the amount of coded information of the higher sequence, as illustrated in FIG. 1. Namely, the original or base layer of a lower sequence may be used to predictively encode an original or base layer of a higher sequence.

In the encoding apparatus shown in FIG. 2, an encoder 20ₖ (where k=1 to 3) of each sequence performs transformation/coding such as Discrete Cosine Transformation (DCT) and quantization on data encoded by motion estimation and prediction operations. The resulting encoded sequence is referred to as a base or original layer. The quantization causes an information loss in the base or original layer. Thus, the encoder 20ₖ of each sequence performs inverse quantization 201ₖ and inverse transformation 202ₖ to reconstitute the sequence prior to DCT and quantization. A difference is then obtained between the actual sequence prior to DCT and quantization and the reconstituted sequence. This difference represents data lost during the DCT and quantization process. This difference is then transformed/coded such as DCT and quantization to produce residual sequence layer data or SNR enhancement layer data. The residual sequence layer data may undergo the same process to produce a higher level of SNR enhancement layer data, and higher levels of SNR enhancement layer data may also undergo the same process to obtain still higher levels of residual sequence layer data. For the sake of simplicity, the various levels of SNR enhancement data will be collectively referred to as SNR enhancement layer data or residual sequence layer data. The SNR enhancement layer data is provided such that the image quality can be gradually improved by increasing the decoding level of the SNR enhancement layer data, which is referred to as Fine Grained Scalability. Namely, the more levels of residual sequence layer data that are decoded and added to the associated base layer, the higher the quality of the resulting image. Because the number of levels of SNR enhancement layer data is controllable or selectable, these fine grain improvements in quality are scalable; hence the name, Fine Grained Scalability or FGS.

All the sequences encoded as shown in FIG. 1 are not transmitted to a decoding apparatus. Instead, an extractor 22 transmits a stream selected depending on transmission channel bandwidth and the type of a sequence currently requested by the decoding apparatus. For example, as shown in FIG. 3, when the decoding apparatus currently requests a CIF sequence and the transmission channel bandwidth permits, data 301 of an SNR base layer of a QCIF sequence, data 302 of an SNR base layer of a CIF sequence, data 303 of an SNR enhancement layer of the QCIF sequence, and data 304 of an SNR enhancement layer of the CIF sequence are, in the named order, extracted in specific units from a storage unit 21 and a data stream including such extracted data is then transmitted. That is, in each transmission stream segment 310, the enhancement layers of the sequences are transmitted after all the base layers of the sequences are transmitted, and the sequences in each layer are transmitted in increasing order of their transfer rates. If the transmission channel bandwidth is reduced during transmission, the extractor 22 transmits only up to a transmittable bit, thereby failing to transmit the subsequent bitstream in each transmission segment 310. For example, in the case of FIG. 3, part of the data bitstream, starting from high-precision error compensation data part (i.e., the LSB of the error compensation data) of the SNR enhancement layer of the CIF sequence, is not transmitted.

The above method, which sequentially transmits sequences in increasing order of their transfer rates, may unnecessarily occupy the transmission channel due to transmission of unnecessary data, which is not used by the decoding apparatus. For example, when the decoding apparatus decodes only the CIF sequence to display video to the user in the example of FIG. 3, the SNR enhancement layer data of the QCIF sequence is transmitted although the SNR enhancement layer data is not used while the SNR base layer data of the QCIF sequence is used for prediction of the SNR base layer frame of the CIF sequence.

Moreover, when the transmission channel bandwidth is reduced, the SNR enhancement layer data of the QCIF sequence is transmitted although it actually makes no contribution to improving the image quality, whereas the amount of transmitted data of the enhancement layer of the CIF sequence is reduced although it directly contributes to improving the image quality.

### SUMMARY OF THE INVENTION

The present invention relates to a method and apparatus for encoding, transmitting and decoding a video signal.

In one embodiment of a method of decoding a video signal, at least a portion of a picture in a first picture sequence layer is decoded based on a second picture sequence layer if an indicator in the video signal indicates inter-layer prediction coding.

For example, the second picture sequence layer may have a lower frame rate than the first picture sequence layer, may have a bitrate less than a bitrate of the first picture sequence layer, may have a picture resolution less than the first picture sequence layer, and/or may have a picture display size less than the first frame sequence.

In one embodiment, the picture in the first picture sequence layer is a base picture, where a base picture has a base level of quality for the first picture sequence layer. Here, the decoding step may include improving the quality level of the decoded base picture using enhancement layer picture information associated with the base picture.

In another embodiment, a value of the indicator greater than zero indicates inter-layer prediction coding for the base picture.

In a further embodiment of a method of decoding a video signal, at least a portion of a picture in a first picture sequence layer is decoded based on at least a portion of a second picture sequence layer base picture in a second picture sequence layer and enhancement layer picture information associated with the second picture sequence layer base picture according to a quality level represented by an indicator in the video signal. The second picture sequence layer base picture has a base level of quality for the second picture sequence layer, and the enhancement layer picture information associated with the second picture sequence layer base picture provides information to improve the quality level of the second picture sequence layer base picture.

For example, the second picture sequence layer base picture may be decoded based on the enhancement layer picture information according to the quality level represented by the indicator to produced an enhanced picture, and the portion of the picture in the first picture sequence layer may be decoded based on the enhanced picture.

According to an embodiment of an apparatus for decoding a video signal, a decoder decodes at least a portion of a picture in a first picture sequence layer based on a second picture sequence layer if an indicator in the video signal indicates inter-layer prediction coding.

According to an embodiment of a method of encoding a video signal, at least a portion of a picture in a first picture sequence layer is encoded based on a second picture sequence layer and an indicator in the video signal is set to indicate inter-layer prediction coding of the picture in the first picture sequence layer.

In an embodiment of an apparatus for encoding a video signal, an encoder encodes at least a portion of a picture in a first picture sequence layer based on a second picture sequence layer and sets an indicator in the video signal to indicate inter-layer prediction coding of the picture in the first picture sequence layer.

According to yet another embodiment, a bitstream representing a video signal has a data structure, includes a first stream portion representing at least a portion of a picture in a first picture sequence layer encoded based on a second picture sequence layer, and includes an indicator to indicate inter-layer prediction coding of the picture in the first picture sequence layer.

### BRIEF DESCRIPTION OF DRAWINGS

The accompanying drawings, which are included to provide a further understanding of the invention, illustrate the preferred embodiments of the invention, and together with the description, serve to explain the principles of the present invention.

FIG. 1 illustrates an example of sequences having different screen sizes and/or different frame rates into which a video signal is encoded through inter-sequence prediction;

FIG. 2 is a block diagram of an apparatus for encoding the video signal into the sequences as shown in FIG. 1 and transmitting the sequences;

FIG. 3 illustrates a transmission format of data that the encoding apparatus of FIG. 2 extracts and transmits upon receiving a CIF sequence transmission request from a decoder;

FIG. 4 is a block diagram of an apparatus for encoding a video signal into sequences having different screen sizes and/or different frame rates through inter-sequence prediction of the video signal according to an embodiment of the present invention;

FIG. 5 illustrates sequences encoded by the apparatus of FIG. 4 and a transmission format of data that the apparatus of FIG. 4 extracts and transmits from the encoded sequences according to an embodiment of the present invention;

FIG. 6 illustrates a transmission format of data extracted from the encoded sequences according to another embodiment of the present invention; and

FIG. 7 is a block diagram of an apparatus for decoding a data stream encoded by the apparatus of FIG. 4.

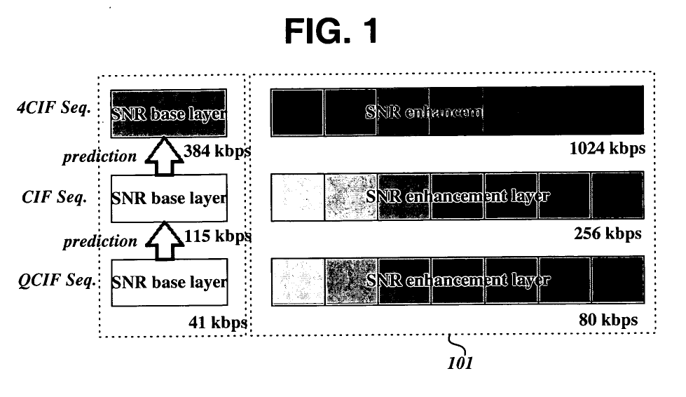

Features, elements, and aspects of the invention that are referenced by the same numerals in different figures represent the same, equivalent, or similar features, elements, or aspects in accordance with one or more embodiments.

### DETAILED DESCRIPTION OF EXAMPLE EMBODIMENTS

Example embodiments of the present invention will now be described in detail with reference to the accompanying drawings.

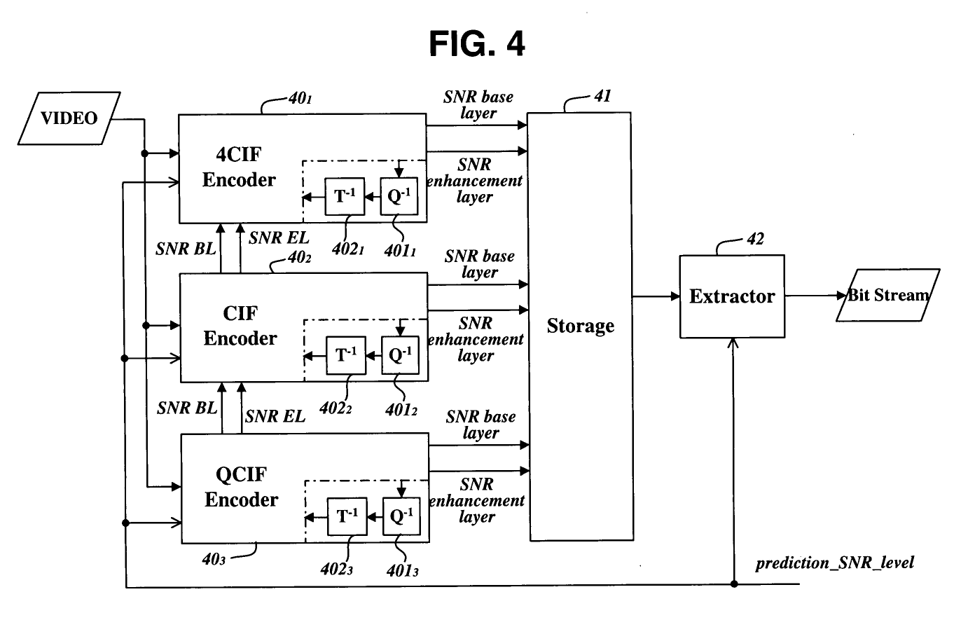

FIG. 4 is a block diagram of a video signal encoding apparatus to which an encoding and transmission method according to the present invention is applied.

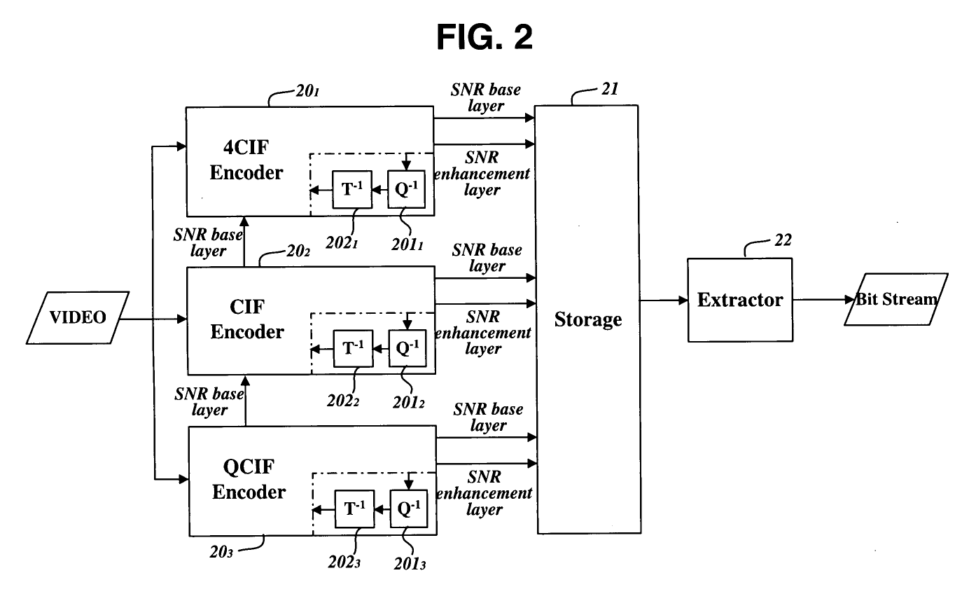

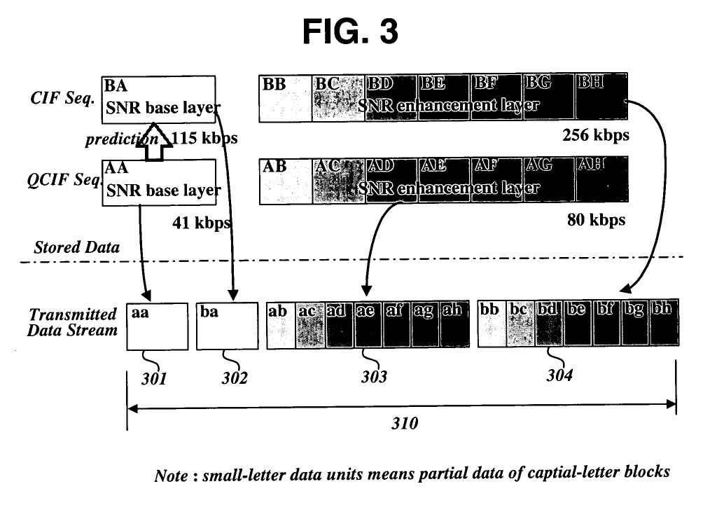

The video signal encoding apparatus of FIG. 4 is similar in structure to the apparatus of FIG. 2. However, sequence encoders 40ₖ and an extractor 42 in the apparatus of FIG. 4 have different features from those of the apparatus of FIG. 2. The video signal encoding apparatus of FIG. 4 will now be described in detail, focusing on the sequence encoders 40ₖ and the extractor 42.

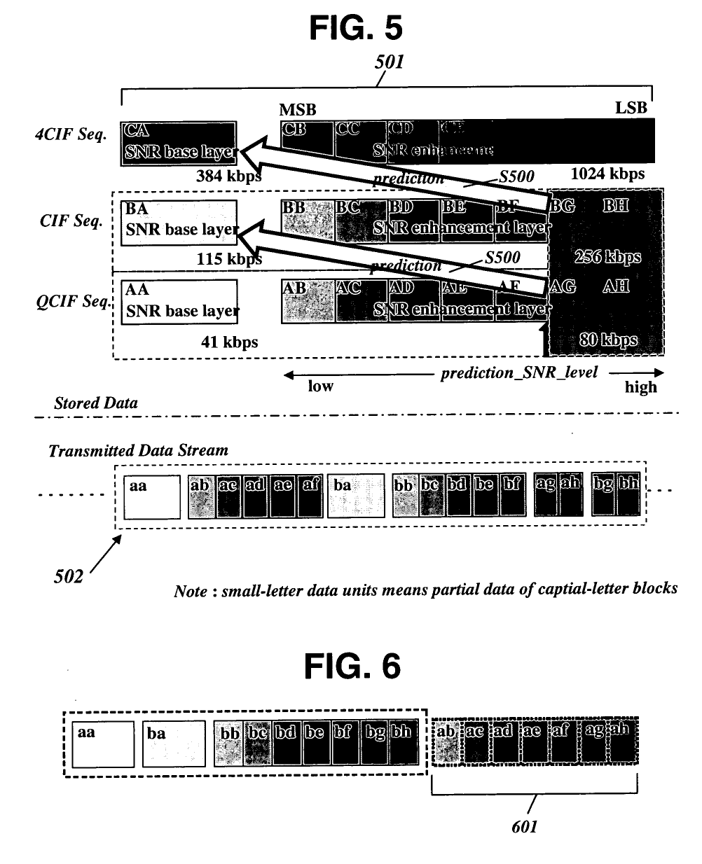

Each of the encoders 40₂ and 40₃ of lower picture sequences having different picture or display sizes (e.g., different resolution) and/or different frame rates provide not only data of an SNR base layer but also data of an SNR enhancement layer (or residual sequence layer) to a corresponding one of the encoders 40₁ and 40₂ of higher picture sequences. As illustrated in FIG. 5, each of the encoders 40₁ and 40₂ of the higher sequences uses video frames reconstructed by using both the SNR base layer data and the associated SNR enhancement layer data of the lower sequence when performing inter-sequence prediction of video frames present in the sequence produced by each of the encoders 40₁ and 40₂ (S500). Here, the level of the SNR enhancement layer data to be used for video reconstruction is determined and set in each encoder 40ₖ based on conditions, such as an image quality to be provided and a secured transmission channel capacity. This level is then indicated by inserting a field or flag prediction_SNR_level inserted in headers (for example, slice or picture headers) of the encoded SNR base layer data stream so that the level value is transferred to a decoder. The prediction_SNR_level value indicates the level value.

The prediction_SNR_level is also set in the extractor 42 of the encoding apparatus of FIG. 4. From each encoded data stream 501 stored in a storage unit 41, the extractor 42 extracts and transmits data for a picture sequence currently requested by a decoding apparatus. FIG. 5 shows an arrangement of data units of each data stream segment transmitted when the decoding apparatus requests a CIF sequence and bandwidth required for the transmission channel is available.

For CIF sequence transmission, the extractor 42 first arranges a data unit aa of the SNR base layer of its lower (i.e., QCIF) sequence and subsequently arranges data units ab, ac, ad, ae and af up to the set prediction_SNR_level from among data units ab to ah of the SNR enhancement layer of the QCIF sequence. The extractor 42 subsequently arranges a data unit ba of the SNR base layer of the CIF sequence and data units bb, bc, bd, be and bf up to the set prediction_SNR_level from among data units bb to bh of the SNR enhancement layer of the CIF sequence. Finally, the extractor 42 arranges remaining data units ag and ah of the SNR enhancement layer of the QCIF sequence, subsequent to the data units bb to bf, and arranges remaining data units bg and bh of the SNR enhancement layer of the CIF sequence, subsequent to the remaining data units ag and ah, and then transmits the arranged data stream.

The remaining data units ag and ah of the SNR enhancement layer of the QCIF sequence are not used when the video of the CIF sequence is presented. The remaining data units ag and ah of the SNR enhancement layer of the QCIF sequence, which are not used in the prediction operation, are arranged and transmitted in the data stream when the transmission channel bandwidth permits because the user may view video of the QCIF sequence using a device having a low decoding capability such as a mobile phone after storing the data transmitted from the extractor 42.

Alternatively, the extractor 42 may arrange the remaining data units bg and bh of the SNR enhancement layer of the CIF sequence, subsequent to the data units bb to bf of the SNR enhancement layer of the CIF sequence up to the set prediction_SNR_level. Then the extractor 42 may arrange the remaining data units ag and ah of the SNR enhancement layer of the QCIF sequence at the end of the data stream, and transmit the arranged data stream.

In the transmission method as shown in FIG. 5, when the transfer rate is reduced due to deterioration of the transmission channel conditions, part of the data stream, starting from the SNR enhancement layer data of the QCIF sequence that makes no contribution to improving the image quality of currently decoded video, is not transmitted. If the channel conditions are further deteriorated, part of the data stream is not transmitted in the order from data that slightly increases the SNR of video to data that greatly increases the SNR of video. That is, the image quality of decoded video is resistant to variations in the channel conditions, as compared to the conventional transmission method.

If the prediction_SNR_level is set to zero, SNR enhancement layer data of a lower sequence is not used for prediction of frames of a higher sequence, so that the SNR enhancement layer data of the lower sequence is not transmitted. Accordingly, a non-zero value of the prediction_SNR_level indicates that inter-layer prediction has taken place, while a zero value indicates no inter-layer prediction. When sufficient transmission channel bandwidth is available, data of an SNR enhancement layer of a currently selected sequence is arranged and transmitted in a transmission segment and data of an SNR enhancement layer of a lower sequence is subsequently arranged and transmitted in the transmission segment.

An example of such a case is illustrated in FIG. 6, in which a CIF sequence is selected so that data of an SNR enhancement layer of a QCIF sequence is not transmitted in a data stream. Even if the data of the SNR enhancement layer of the QCIF sequence is transmitted, it is arranged and transmitted at the end of the data stream (601).

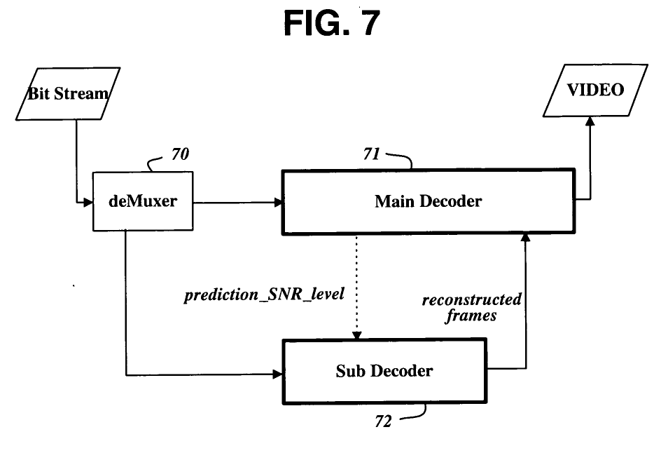

FIG. 7 is a block diagram of an embodiment of an apparatus for decoding a data stream encoded and transmitted by the apparatus of FIG. 4. The decoding apparatus of FIG. 7 receives a plurality of sequences and decodes a higher sequence into a video signal, and includes a demuxer (or demultiplexer) 70, a main decoder 71, and a sub-decoder 72. The demuxer 70 separates a received data stream into a data stream of a main sequence and a data stream of a sub-sequence. The main decoder 71 converts the data stream of the separated main sequence (for example, a CIF sequence) back to an original video signal according to an MCTF scheme. The sub-decoder 72 decodes the data stream of the separated sub-sequence (for example, a QCIF sequence) according to a specified scheme, for example, according to the MPEG4 or H.264 standard.

The main decoder 71 reads the prediction_SNR_level described above from a header of the input data stream and notifies the sub-decoder 72 of the prediction_SNR_level. The notification of prediction_SNR_level between the decoders is not necessary in an embodiment where the prediction_SNR_level is recorded and transmitted in each of the sequences.

When decoding the received data stream of the sub-sequence, the sub-decoder 72 decodes SNR base layer data which may be included, together with the SNR enhancement layer, in the received data stream. Then, the sub-decoder 72 provides the main decoder 71 with frames that are decoded to improve the image quality of video using data up to the notified prediction_SNR_level, from among SNR enhancement layer data included in the received data stream of the sub-sequence.

The main decoder 71 decodes frames in the received main sequence, for which frames in the sub-sequence are used as their predictive images, into original video signals based on images predicted from frames provided from the sub-decoder 72 or, if needed, from scaled versions of these frames.

The decoding apparatus described above may be incorporated into a mobile communication terminal, a media player, or the like.

As is apparent from the above description, an apparatus and method for encoding and decoding a video signal according to the present invention performs inter-sequence prediction using video frames reconstructed by additionally using error compensation data (e.g., SNR enhancement layer data or residual sequence layer data), thereby improving the image quality relative to the amount of coded data. The apparatus and method also arrange and transmit encoded data units sequentially starting from data units which greatly affect the image quality of a sequence that currently needs to be decoded, thereby making the image quality less sensitive to variations in the channel capacity. Also, the transfer rate may be reduced to more efficiently allocate the transmission channel.

Although the example embodiments of the present invention have been disclosed for illustrative purposes, those skilled in the art will appreciate that various modifications, additions and substitutions are possible, without departing from the scope and spirit of the invention.

1. A method of decoding a video signal, comprising:
decoding at least a portion of a picture in a first picture sequence layer based on a second picture sequence layer if an indicator in the video signal indicates inter-layer prediction coding.

2. The method of claim 1, wherein the second picture sequence layer has a lower frame rate than the first picture sequence layer.

3. The method of claim 1, wherein a bitrate of a bitstream representing the second picture sequence layer is less than a bitrate of a bitstream representing the first picture sequence layer.

4. The method of claim 1, wherein a resolution of pictures in the second picture sequence layer is less than a resolution of pictures in the first picture sequence layer.

5. The method of claim 1, wherein the display size of picture in the second picture sequence layer is less than a display size of pictures in the first frame sequence.

6. The method of claim 1, wherein the picture in the first picture sequence layer is a base picture, the base picture having a base level of quality for the first picture sequence layer.

7. The method of claim 6, wherein the decoding step includes improving the quality level of the decoded base picture using enhancement layer picture information associated with the base picture.

8. The method of claim 6, further comprising:
obtaining the indicator from a slice header of the base picture.

9. The method of claim 6, wherein a value of the indicator greater than zero indicates inter-layer prediction coding for the base picture.

10. The method of claim 9, further comprising:
obtaining the indicator from a slice header of the base picture.

11. The method of claim 6, wherein a zero value of the indicator indicates no inter-layer prediction coding.

12. The method of claim 11, further comprising:
obtaining the indicator from a slice header of the base picture.

13. The method of claim 1, wherein a value of the indicator greater than zero indicates inter-layer prediction coding.

14. The method of claim 13, further comprising:
obtaining the indicator from a slice header of the video signal.

15. The method of claim 13, wherein a zero value of the indicator indicates no inter-layer prediction coding.

16. The method of claim 15, further comprising:
obtaining the indicator from a slice header of the video signal.

17. The method of claim 1, wherein a zero value of the indicator indicates no inter-layer prediction coding.

18. The method of claim 17, further comprising:
obtaining the indicator from a slice header of the video signal.

19. The method of claim 1, further comprising:
obtaining the indicator from a slice header of the video signal.

20. The method of claim 1, wherein the decoding step decodes the portion of the picture in the first picture sequence layer based on at least a portion of a second picture sequence layer base picture and enhancement layer picture information associated with the second picture sequence layer base picture according to a quality level represented by the indicator, the second picture sequence layer base picture having a base level of quality for the second picture sequence layer and the enhancement layer picture information associated with the second picture sequence layer base picture providing information to improve the quality level of the second picture sequence layer base picture.

21. The method of claim 20, wherein the decoding step decodes the second picture sequence layer base picture based on the enhancement layer picture information according to the quality level represented by the indicator to produced an enhanced picture, and decodes the portion of the picture in the first picture sequence layer based on the enhanced picture.

22. The method of claim 21, wherein the enhanced picture has a finer quality than the second picture sequence layer base picture.

23. The method of claim 21, wherein the picture in the first picture sequence layer is a first picture sequence layer base picture having a base level of quality for the first picture sequence layer.

24. The method of claim 20, wherein the picture in the first picture sequence layer is a first picture sequence layer base picture having a base level of quality for the first picture sequence layer.

25. A method of decoding a video signal, comprising:
decoding at least a portion of a picture in a first picture sequence layer based on at least a portion of a second picture sequence layer base picture in a second picture sequence layer and enhancement layer picture information associated with the second picture sequence layer base picture according to a quality level represented by an indicator in the video signal, the second picture sequence layer base picture having a base level of quality for the second picture sequence layer and the enhancement layer picture information associated with the second picture sequence layer base picture providing information to improve the quality level of the second picture sequence layer base picture.

26. The method of claim 25, wherein the decoding step decodes the second picture sequence layer base picture based on the enhancement layer picture information according to the quality level represented by the indicator to produced an enhanced picture, and decodes the portion of the picture in the first picture sequence layer based on the enhanced picture.

27. The method of claim 26, wherein the enhanced picture has a finer quality than the second picture sequence layer base picture.

28. The method of claim 26, wherein the picture in the first picture sequence layer is a first picture sequence layer base picture having a base level of quality for the first picture sequence layer.

29. The method of claim 25, wherein the picture in the first picture sequence layer is a first picture sequence layer base picture having a base level of quality for the first picture sequence layer.

30. The method of claim 25, further comprising:
obtaining the indicator from a slice header of the video signal.

31. An apparatus for decoding a video signal, comprising:
a decoder decoding at least a portion of a picture in a first picture sequence layer based on a second picture sequence layer if an indicator in the video signal indicates inter-layer prediction coding.

32. A method of encoding a video signal, comprising:
encoding at least a portion of a picture in a first picture sequence layer based on a second picture sequence layer and setting an indicator in the video signal to indicate inter-layer prediction coding of the picture in the first picture sequence layer.

33. An apparatus for encoding a video signal, comprising:
an encoder encoding at least a portion of a picture in a first picture sequence layer based on a second picture sequence layer and setting an indicator in the video signal to indicate inter-layer prediction coding of the picture in the first picture sequence layer.

34. A bitstream representing a video signal having a data structure, comprising:
a first stream portion representing at least a portion of a picture in a first picture sequence layer encoded based on a second picture sequence layer and including an indicator to indicate inter-layer prediction coding of the picture in the first picture sequence layer.
